(19) United States
(12) Patent Application Publication
(10) Pub. No.: US 2005/0095418 A1
(43) Pub. Date: May 5, 2005

(54) Antistatic film, antistatic foam sheet and antistatic bubble sheet

(76) Inventors: Toshio Nakano, Fukui-ken (JP); Hideki Tanaka, Fukui-ken (JP); Yoshikatsu Michimasa, Fukui-ken (JP); Asanori Yoshida, Fukui-ken (JP); Kazuhiro Kamon, Tochigi-ken (JP); Sadayuki Nishimiya, Tochigi-ken (JP)

Correspondence Address: BLACKWELL SANDERS PEPER MARTIN LLP, 720 OLIVE STREET, SUITE 2400, ST. LOUIS, MO, 63101, US

(21) Appl. No.: 10/698,585

(22) Filed: Oct. 31, 2003

(51) Int. Cl. B32B 5/22

(52) U.S. Cl. 428/317.9

(57) ABSTRACT

To provide an antistatic film, an antistatic foam sheet or an antistatic bubble sheet which has favorable physical properties, such as a continued antistatic effect and a high strength, and which causes little contamination of rollers or other devices when the sheet is formed. The antistatic film according to the present invention is characterized in that it is made of a polyethylene-based resin composition containing a polyethylene-based resin and a high-polymer-type, polyether-based antistatic agent. Furthermore, the antistatic foam sheet and the bubble sheet according to the present invention are characterized in that they are made of a polyolefin-based resin composition containing a polyolefin-based resin and a high-polymer-type antistatic agent.

### BACKGROUND

The present invention relates to an antistatic film, an antistatic foam sheet and an antistatic bubble sheet, and more specifically, to an antistatic film, an antistatic foam sheet and an antistatic bubble sheet having a favorable antistatic effect.

Polyethylene film is used widely in areas, such as food industry, industrial materials, and agriculture due to its favorable properties, such as high chemical resistance, impact resistance, abrasion resistance and heat stability or low water absorption. Polyethylene film, however, can easily build up electrostatic charges, and can cause dust pick-up and other problems.

To prevent these problems due to the electrostatic property of polyethylene film, certain measures have been conventionally taken, such as kneading a surface active agent or other low-molecular-weight-type antistatic agents into a polyethylene resin and making a film out of such material, or applying a low-molecular-weight-type antistatic agent to the polyethylene film itself.

Nonetheless, if a low-molecular-weight-type antistatic agent is kneaded into a polyethylene-based resin, the antistatic agent migrates to the surface of the film and brings an antistatic effect to the film. Due to this characteristic, the antistatic agent is dependent on the bleeding speed, as well as the water adsorption equilibrium, such that it is difficult to control the properties of the film. Especially, there is limitation to the long-term durability of the film, and the antistatic effect of the film is not maintained. Furthermore, there are other problems, such as greasy film surface.

Moreover, when a low-molecular-weight-type antistatic agent is kneaded into a resin having a high crystallinity, such as a high-density polyethylene, the bleeding-out of the antistatic agent becomes difficult and the film demonstrates insufficient antistatic effect. However, if, in such case, the amount of the antistatic agent added to the resin is increased, this can result in reduced strength or other types of deterioration in the physical properties of the film.

Foam sheets or bubble sheets made of polyolefins also have these problems when electrostatic charges are built up.

### SUMMARY

The present invention aims at solving the conventional problems outlined above. It is an object of the present invention to provide an antistatic film, an antistatic foam sheet and an antistatic bubble sheet, which can be prepared without increasing the amount of antistatic agent added to the resin, and which demonstrates a favorable antistatic effect for an extended period of time, and in which the deterioration in physical properties is minimized.

In order to meet this objective, the present invention provides an antistatic film that is made of a polyethylene-based resin composition containing a polyethylene-based resin and a high-polymer-type, polyether-based antistatic agent.

The antistatic film having such a structure demonstrates a favorable antistatic effect over an extended period of time, and the deterioration in the physical properties of such film is minimized.

The film preferably has a surface resistivity of approximately 1×10¹⁰ to 1×10¹⁴Ω, and a surface resistivity of 1×10¹⁴Ω or less after the film has undergone a rinsing process.

The aforementioned high-polymer-type antistatic agent is preferably added to the polyethylene-based resin at a ratio of polyethylene-based resin: high-polymer-type antistatic agent=97˜80:3˜20. More preferably, the high-polymer-type antistatic agent is added to the polyethylene-based resin at a ratio of polyethylene-based resin: high-polymer-type antistatic agent=97˜90:3˜10.

Furthermore, the present invention provides an antistatic foam sheet made of a polyolefin-based resin composition containing a polyolefin-based resin and a high-polymer-type antistatic agent.

It is preferred that the high-polymer-type antistatic agent is a high-polymer-type, polyether-based antistatic agent, and that the polyolefin-based resin is a polyethylene-based resin.

The high-polymer-type antistatic agent is preferably added to the polyolefin-based resin at a ratio of polyolefin-based resin: high-polymer-type antistatic agent=97˜80:3˜20. More preferably, the high-polymer-type antistatic agent is added to the aforementioned polyethylene-based resin at a ratio of polyolefin-based resin: high-polymer-type antistatic agent=97˜90:3˜10.

Moreover, the present invention provides an antistatic bubble sheet made of a polyolefin-based resin composition containing a polyolefin-based resin and a high-polymer-type antistatic agent.

### DETAILED DESCRIPTION

The antistatic film, the antistatic foam sheet and the antistatic bubble sheet according to the present invention will be respectively explained below.

Antistatic Film

The antistatic film according to the present invention is made of a polyethylene-based resin composition containing a polyethylene-based resin and a high-polymer-type, polyether-based antistatic agent, and demonstrates a favorable antistatic property.

The polyethylene-based resin used for the antistatic film according to the present invention may be, for example, an ethylene homopolymer or a copolymer of ethylene and other α-olefins, and more particularly, a high-density polyethylene (hereinafter may be referred to as “HDPE”), a medium-density polyethylene (hereinafter may be referred to as “MDPE”), a low-density polyethylene (hereinafter may be referred to as “LDPE”), or a linear, low-density polyethylene (hereinafter may be referred to as “LLDPE”). More specifically, examples of “other α-olefins” above may be propylene, 1-butene, 4-methyl-1-pentene, 1-pentene, 1-octene, 1-decene, and 1-dodecene. Moreover, there is no particular limitation to the crystallinity of the polyethylene-based resin.

The high-polymer-type, polyether-based antistatic agent used for the antistatic film according to the present invention may be polyethylene oxides, cross-linked polyethylene oxides, copolymers of polyethylene oxides and other resins, polyethylene glycols, and copolymers of polyethylene glycols and other resins.

The high-polymer-type, polyether-based antistatic agent may be added to the polyethylene-based resin at a ratio of polyethylene-based resin: high-polymer-type, polyether-based antistatic agent=97˜80:3˜20. Preferably, the high-polymer-type, polyether-based antistatic agent is added to the polyethylene-based resin at a ratio of polyethylene-based resin: high-polymer-type, polyether-based antistatic agent=97˜90:3˜10. If the amount of the high-polymer-type antistatic agent added to the polyethylene-based resin remains within such range, there is no problem in the formability of the film.

Furthermore, other known additives for resins may be added to the ethylene-based resin composition that is used for the antistatic film according to the present invention to the extent that such additives do not hinder the positive effects of the present invention. More particularly, additives for resins may be, for example, antioxidants, neutralizers, slip additives, nucleating agents, fillers such as silica, cross-linked organic particulates or the like, ultraviolet absorbents, photo stabilizers, plasticizers, release materials, flame retarders, or surface active agents.

The antistatic film according to the present invention preferably has a surface resistivity of approximately 1×10¹⁰ to 1×10¹⁴Ω. The surface resistivitiy is measured using a super megohmmeter based on the ASTM D257 standard.

The antistatic film according to the present invention can be manufactured using conventional methods, such as the inflation method.

Antistatic Foam Sheet

The antistatic foam sheet according to the present invention is made of a polyolefin-based resin composition containing a polyolefin-based resin and a high-polymer-type antistatic agent, and demonstrates a favorable antistatic property.

The Polyolefin-based resin used for the antistatic foam sheet according to the present invention may be polyethylene (e.g., low-density, medium-density or high-density polyethylene, or linear, low-density polyethylene), polypropylene, and a copolymer of ethylene or propylene and other α-olefins, or a copolymer of ethylene and vinyl acetate, (meth)acrylic acid, (meth)acrylate, vinylalcohol, or a blend thereof.

Furthermore, the high-polymer-type antistatic agent used for the antistatic foam sheet according to the present invention can be any polymer to the extent that such polymer provides the antistatic foam sheet with conductivity when blended into the polyethylene-based resin, thereby demonstrating an antistatic property. High-polymer antistatic agents can generally be classified into non-ionic, anionic, cationic, or anionic/cationic types based on their ionicities. Furthermore, high-polymer-type antistatic agents can, for example, be classified into the following groups based on their chemical structures: (a) non-ionic, polyether-based, high-polymer-type antistatic agents, such as polyethylene oxides, cross-linked polyethylene oxides, copolymers of polyethylene oxides and other resins, polyethylene glycols, or copolymers of polyethylene glycol and other resins; (b) cationic high-polymer-type antistatic agents, such as quaternary ammonium salts-based (copolymers containing quaternary ammonium bases, (meth)acrylate copolymers containing quaternary ammonium bases, maleimide copolymers containing quaternary ammonium bases, methacrylimide copolymers containing quaternary ammonium bases); (c) anionic high-polymer-type antistatic agents, such as sulfonic-based acids (polysterene sulfonic acid soda); and (d) anionic/cationic (betaine-based) high-polymer-type antistatic agents, such as carbobataine graft copolymers. In addition to the foregoing, new types of high-polymer(-type) antistatic agents, such as polyamide-based polymers, or boron-based polymers can also be used.

The high-polymer-type antistatic agent is preferably added at a ratio of polyolefin-based resin: high-polymer-type antistatic agent=97˜80:3˜20. More preferably, the high-polymer-type antistatic agent is added at a ratio of polyolefin-based resin high-polymer-type antistatic agent=97˜90:3˜10. If the high-polymer-type antistatic agent is added within the range above, there is no problem in the formability of the film.

The foaming agent that can be used for the antistatic foam sheet according to the present invention may be: (a) chemical foaming agents, such as azodicarbonamide, azobisisobutyronitrile, diazoaminobenzene, N,N′-dinitrosopentamethylenetetramine, N,N′-dimethyl-N,N-dinitroterephthalamide, benzenesulfonylhydrazide, p-toluenesulfonyl hydrazide, p,p′-oxybis (benzenesulfonyl hydrazide), carbonate and organic acid; and (b) physical foaming agents, such as propane, butane, pentane, dichlorodifluoromethan, dichloromonofluoromethane, trichloromonofluoromethane, methanol, ethanol and water.

Furthermore, other known additives for resins may be added to the ethylene-based resin composition that-is used for the antistatic foam sheet according to the present invention to the extent that such additives do not hinder the positive effects of the present invention. More particularly, such additives may be, for example, antioxidants, neutralizers, slip additives, nucleating additives, fillers such as silica, cross-linked organic particulates or the like, ultraviolet absorbents, photo stabilizers, plasticizers,release materials, flame retarders, or surface active agents.

The foam sheet can be formed by, for example, fusing and kneading any of the aforementioned polyolefin-based resins, foaming agents and other additives (included as necessary) at the decomposing temperatures of the foaming agents, using blending and kneading devices, such as single screw extruders, twin screw extruders, Banbury mixers, kneader mixers, or rollers, thereby preparing a foaming resin composition, and forming the prepared resin composition into a sheet.

Antistatic Bubble Sheet

The antistatic bubble sheet according to the present invention is a bubble sheet having an antistatic property, and is made of the same polyolefin-based resin composition containing a polyolefin-based resin and a high-polymer-type antistatic agent, as explained in the antistatic foam sheet section above.

The antistatic bubble sheet according to the present invention preferably has a surface resistivity of 1×10¹⁴Ω or less. The surface resistivity here is a value that is measured using the super megohmmeter, based on the ASTM D257 standard.

The bubble sheet above can be manufactured using conventional manufacturing methods, such as the method disclosed in Patent-Kokoku Publication No. SHO 40-16875 or in Patent Laid-Open (Kokai) Publication No. SHO 61-5923.

### PREFERRED EMBODIMENTS

The present invention will be explained in further detail by describing the preferred embodiments. The present invention, however, shall not be limited to these embodiments to the extent that it remains within the range of the technology outlined in relation to these embodiments.

### Embodiment 1

A high-density polyethylene (HDPE) and a high-polymer-type antistatic agent (manufactured by Sanyo Chemical Industries, Ltd.; product name: “Pelestat 300”) were supplied to an extruder at a ratio of 95:5, and fused and kneaded at approximately 200° C. The fused resin was extruded from a circular die, and a fused tube was thus prepared. Air was then blown inside of the tube, causing the tube to inflate. The inflated tube was cooled down by a blowing process, in which air was blown on the tube circumference, and was then formed into an inflated film (antistatic film) having a thickness of 10 μm.

Furthermore, antistatic films having thicknesses of 15 μm and 20 μm were also formed using the same method as explained above.

The prepared antistatic films were evaluated by the following tests and measurements. The results are shown in Table 1 below.

(1) Measurement of Surface Resistivity

The surface resistivities of the prepared antistatic films were measured based on the ASTM D257 standard.

The surface resistivities were evaluated by performing the following processes in relation to the test pieces (made of the respective antistatic films) and by measuring the surface resistivities of the test pieces.

(a) Test Nieces That did not Undergo a Rinsing Process (Test Pieces Prior to the Rinsing Process)

After the forming of the films, test pieces were left standing for another 24 hours at a temperature of 23° C. and at a relative humidity of 50%.

(b) Test Pieces that Underwent a Rinsing Process (Test Pieces After the Rinsing Process)

After the forming of the films, test pieces were dipped in water and the surfaces of the test pieces were rinsed using a cotton cloth. Next, the test pieces were dried for an hour under reduced pressure (a pressure of 1 mmHg) at a temperature of 70° C. and were then left standing for another 24 hours at a temperature of 23° C. and at a relative humidity of 50%.

(2) Evaluation of Roller Contamination

The level of contamination of the casting roller, which first contacted the film extruded from the die outlet, was evaluated visually.

[Evaluation Standards]

◯: Almost no contamination is recognized.

Δ: Little contamination is recognized, but continuous production will not be hindered.

x: Contamination is recognized and continuous production will be hindered.

### Embodiment 2

An antistatic film was formed using the same method as in Embodiment 1 except that the high-polymer-type antistatic agent was blended into the HDPE at a ratio of 97:3. The antistatic film was then evaluated using the same method as in Embodiment 1. The results are shown in Table 1 below.

Comparison 1

An antistatic film was formed using the same method as in Embodiment 1 except that an antistatic agent manufactured by Kao Corporation (product name: “HE110”) was used instead of the high-polymer-type antistatic agent used in Embodiment 1. The antistatic film was then evaluated using the same method as in Embodiment 1. The results are shown in Table 1 below.

TABLE 1

| | | Surface Resistivity (Ω) | | |
|---|---|---|---|---|
| | Film | Before the | After the | |
| | Thickness | Rinsing | Rinsing | Roller |
| | (μm) | Process | Process | Contamination |
| Embodiment 1 | 10 | 5 × 10¹³ | 6 × 10¹² | ◯ |
| | 15 | 1 × 10¹³ | 1 × 10¹³ | ◯ |
| | 20 | 8 × 10¹² | 8 × 10¹² | ◯ |
| Embodiment 2 | 10 | 7 × 10¹² | 7 × 10¹² | ◯ |
| | 15 | 1 × 10¹³ | 1 × 10¹³ | ◯ |
| | 20 | 1 × 10¹³ | 1 × 10¹³ | ◯ |
| Comparison 1 | 10 | 6 × 10¹³ | 7 × 10¹⁴ | Δ |
| | 15 | 2 × 10¹³ | 8 × 10¹⁴ | Δ |

As shown in Table 1, the antistatic film according to the present invention demonstrated a favorable antistatic property even after being rinsed in water. Furthermore, for the antistatic film according to the present invention, the thickness of the film had almost no influence on the antistatic property of-the film, and thus the film showed a favorable antistatic property for all of the tested thicknesses.

### Embodiment 3

A low-density polyethylene (LDPE) and a high-polymer-type antistatic agent (manufactured by Sanyo Chemical Industries, Ltd.; product name: “Pelestat 300”) were supplied to an extruder at a ratio of 95:5, and fused and kneaded at a temperature of approximately 150° C. The fused resin was extruded from a circular die, and a fused tube was thus prepared. Air was then blown inside of the tube, causing the tube to inflate. The inflated tube was cooled down by a blowing process, in which air was blown on the tube circumference, and was then formed into an inflated film having a thickness of 50 μm.

The prepared antistatic film was evaluated by the following tests and measurements. The results are shown in Table 2 below.

(1) Measurement of Surface Resistivity

The surface resistivities of the prepared antistatic film were measured based on the ASTM D257 standard.

The surface resistivities were evaluated by performing the following processes in relation to the test pieces and by measuring the surface resistivities of the test pieces.

(a) Test Pieces That did not Undergo a Rinsing Process (Test Pieces Prior to the Rinsing Process)

After the forming of the film, test pieces were left standing for another 24 hours at a temperature of 23° C. and a given humidity as shown in Table 2.

(b) Test Pieces That Underwent a Rinsing Process (Test Pieces After the Rinsing Process)

After the forming of the film, test pieces were dipped in water and the surfaces of the test pieces were rinsed using a cotton cloth. Next, the test pieces were dried for an hour under reduced pressure (a pressure of 1 mmHg) at a temperature of 70° C. and were then left standing for another 24 hours at a temperature of 23° C. and at a given humidity as shown in Table 2.

(2) The Contamination of the Roller was Evaluated Under the Same Conditions as in Embodiment 1.

### Embodiment 4

An antistatic film was made using the same method as in Embodiment 3, except that the high-polymer-type antistatic agent was blended into the LDPE at a ratio of 90:10. The antistatic film was then evaluated. The results are shown in Table 2 below.

Comparison 2

An antistatic film was made using the same method as in Embodiment 3, except that an antistatic agent manufactured by Asahi Kasei Corporation (product name: “A203”) was used instead of the high-polymer-type antistatic agent in Embodiment 3. The antistatic film was then evaluated. The results are shown in Table 2 below.

TABLE 2

| | Surface Resistivity (Ω) | | | | |
|---|---|---|---|---|---|
| | | | | After | Roller |
| | | | | the | Con- |
| | Before the | | | Rinsing | tami- |
| | Rinsing Process | | | Process | nation |
| Relative | 30 | 40 | 50 | 50 | — |
| Humidity | | | | | |
| (% RH) | | | | | |
| Embodiment 3 | 3 × 10¹³ | 3 × 10¹³ | 3 × 10¹³ | 3 × 10¹³ | ◯ |
| Embodiment 4 | 2 × 10¹² | 2 × 10¹² | 2 × 10¹² | 2 × 10¹² | ◯ |
| Comparison 2 | 1 × 10¹³ | 7 × 10¹² | 2 × 10¹² | 8 × 10¹⁴ | Δ |

As shown in Table 2, the antistatic film according to the present invention showed a favorable antistatic property after being rinsed in water. Furthermore, in the antistatic film according to the present invention, the level of humidity had almost no influence on the film according to the present invention, and the film showed a favorable antistatic property at all times.

### Embodiment 5

A low-density polyethylene (LDPE) and a high-polymer-type antistatic agent (manufactured by Sanyo Chemical Industries, Ltd.; product name: “Pelestat 300”) were supplied to an extruder at a ratio of 97:3. Volatile gas (butane) was injected into the middle part of the cylinder, and the film was fused and kneaded in the extruder and ejected to a regular pressure environment from a circular die that was attached to the tip of the cylinder opening. Next, the ejected material was drawn using a ring-shaped cooler until it had the prescribed circumference, and was cut open in the extruded direction and an antistatic foam sheet having a thickness of 1 mm was made.

The half-life times of the electrostatic charges (seconds) were measured in relation to the prepared antistatic foam sheet. These measurements were performed at a temperature of 23° C. and at a relative humidity of 50%, using a static honest. meter and applying a voltage of 10 KV.

The antistatic foam sheet was evaluated by performing the following processes in relation to the test pieces and by measuring the half-life times of the electrostatic charges (seconds).

(a) Test Pieces That did not Undergo a Rinsing Process (Test Pieces Prior to the Rinsing Process)

After the forming of the foam sheet, test pieces were left standing for another 48 hours at a temperature of 23° C. and at a relative humidity of 50%.

(b) Test Pieces That Underwent a Rinsing Process (Test Pieces After the Rinsing Process)

After the forming of the foam sheet, test pieces were dipped in water and the surfaces of the test pieces were rinsed using a cotton cloth. The test pieces were dried for two hours under reduced pressure (a pressure of 1 mmHg) at a temperature of 70° C. and were then left standing for another 48 hours at a temperature of 23° C. and at a relative humidity of 50%.

The results are shown in Table 3 below.

Furthermore, due to the foams of the antistatic foam sheet, it was difficult to have the antistatic foam sheet closely contact the electrodes of the surface resistivity measuring device. This made it difficult to measure correctly the surface resistivity of the antistatic foam sheet. It was for this reason that the half-life time of the electrostatic charge (seconds) was measured in relation to the antistatic foam sheet instead of measuring the surface resistivity. The approximate relationship between surface resistivities and half-life times of the electrostatic charges (seconds) is as shown in Table 4 below.

### Embodiment 6

An antistatic foam sheet was made using the same method as in Embodiment 5, except that the high-polymer-type antistatic agent was blended into the LDPE at a ratio of 95:5. The half-life times of the electrostatic charges (seconds) were then measured in relation to such antistatic foam sheet. The results are shown in Table 3 below.

Comparison 3

An antistatic foam sheet was made using the same method as in Embodiment 5, except that an antistatic agent manufactured by Riken Vitamin Co., Ltd. (product name: “MPE-3”) was used instead of the high-polymer-type antistatic agent used in Embodiment 5. The half-life times of the electrostatic charges (seconds) were then measured in relation to such antistatic foam sheet. The results are shown in Table 3 below.

TABLE 3

Half-life Times of
Electrostatic Charges
(Seconds)

| | Before the | After the |
|---|---|---|
| | Rinsing | Rinsing |
| | Process | Process |
| Blank | >180 | >180 |
| Embodiment 5 | 15 | 17 |
| Embodiment 6 | 6 | 5 |
| Comparison 3 | <1 | 30 |

TABLE 4

| Half-life Times of | |
|---|---|
| Electrostatic Charges | Surface |
| (Seconds) | Resistivities (Ω) |
| Up to 1 (exclusive) | Up to 3 × 10¹¹ (exclusive) |
| 1 (inclusive)˜10 (exclusive) | 3 × 10¹¹ (inclusive)˜5 × 10¹² (exclusive) |
| 10 (inclusive)˜60 (exclusive) | 5 × 10¹² (inclusive )˜5 × 10¹³ (exclusive) |
| 60 (inclusive)˜180 (exclusive) | 5 × 10¹³ (inclusive)˜5 × 10¹⁴ (exclusive) |

### Embodiment 7

A low-density polyethylene (LDPE), high-polymer-type antistatic agent (manufactured by Sanyo Chemical Industries, Ltd.; product name: “Pelestat 300”) were supplied to an extruder at a ratio of 95:5. A cap film was extruded from the extruder via the first T-shaped die that supplied the first film. Subsequently, the cap film touched the first cooling roller, and then a forming roller, whereby convexes were vacuum-formed by the concaves provided along the circumference of the forming roller. A backing film was then sent to the forming roller side from the extruder via the second T-shaped die that supplied the second film. The open side of the convexes in the cap film was thus closed. At this time, the cap film and the backing film were pressed and heat fused using a pressure roller. As a result, a sealed antistatic bubble sheet was made.

The surface resistivities of the front and the back faces of the antistatic bubble sheet were measured at a temperature of 18° C. and at a relative humidity of 35%, based on the ASTM D257 standard.

### Embodiment 8

An antistatic bubble sheet was made using the same method as in Embodiment 7 except that the high-polymer-type antistatic agent was blended into the LDPE at a ratio of 90:10, and the surface resistivity of such antistatic bubble sheet was measured.

Comparison 4

An antistatic bubble sheet was made using the same method as in Embodiment 7 except that an antistatic agent manufactured by Riken Vitamin Co., Ltd. (product name: “MPE-3”) was used instead of the high-polymer-type antistatic agent used in Embodiment 7, and measurements were performed in relation to the antistatic bubble sheet.

The same test as in Embodiments 1 through 4 was performed in Embodiments 7 and 8, and Comparison 4, and favorable results were obtained as in Embodiments 1 through 4.

The antistatic film, the antistatic foam sheet and the antistatic bubble sheet according to the present invention has an antistatic effect for an extended period by adding a small amount of an antistatic agent. The antistatic film according to the present invention has favorable physical properties and demonstrates a high antistatic effect without being influenced by the thickness of the film or the change in the humidity.

1. An antistatic film made of a polyethylene-based resin composition containing a polyethylene-based resin and a high-polymer-type, polyether-based antistatic agent.

2. The antistatic film according to claim 1, wherein said film has a surface resistivity of 1×10¹⁴Ω or less after undergoing a rinsing process.

3. The antistatic film according to claim 1 or 2, wherein said high-polymer-type antistatic agent is added to said polyethylene-based resin at a ratio of polyethylene-based resin: high-polymer-type antistatic agent=97˜80:3˜20.

4. An antistatic foam sheet made of a polyolefin-based resin composition containing a polyolefin-based resin and a high-polymer-type antistatic agent.

5. The antistatic foam sheet according to claim 4, wherein said high-polymer-type antistatic agent is a high-polymer-type, polyether-based antistatic agent.

6. The antistatic foam sheet according to claim 4 or 5, wherein said polyolefin-based resin is a polyethylene-based resin.

7. The antistatic foam sheet according to claim 4 or 5, wherein said high-polymer-type antistatic agent is added to said polyolefin-based resin at a ratio of polyolefin-based resin: high-polymer-type antistatic agent=97˜80:3˜20.

8. The antistatic foam sheet according to claim 6, wherein a high-polymer-type antistatic agent is added to said polyolefin-based resin at a ratio of polyolefin-based resin: high-polymer-type antistatic agent=97˜80:3˜20.

9. An antistatic bubble sheet made of a polyolefin-based resin composition containing a polyolefin-based resin and a high-polymer-type antistatic agent.

10. The antistatic bubble sheet according to claim 9, wherein said high-polymer-type antistatic agent is a high-polymer-type, polyether-based antistatic agent.

11. The antistatic bubble sheet according to claim 9 or 10, wherein said polyolefin-based resin is a polyethylene-based resin.

12. The antistatic bubble sheet according to claim 9 or 10, wherein said high-polymer-type antistatic agent is added to said polyolefin-based resin at a ratio of polyolefin-based resin: high-polymer-type antistatic agent=97˜80:3˜20.

13. The antistatic bubble sheet according to claim 11, wherein a high-polymer-type antistatic agent is added to said polyolefin-based resin at a ratio of polyolefin-based resin: high-polymer-type antistatic agent=97˜80:3˜20.
